(19) United States
(12) Patent Application Publication
(10) Pub. No.: US 2003/0230195 A1
(43) Pub. Date: Dec. 18, 2003

(54) Purification of natural hydrocarbons

(75) Inventor: Robert Alexander Leask, Aberdeenshire (GB)

Correspondence Address: HESLIN ROTHENBERG FARLEY & MESITI PC, 5 COLUMBIA CIRCLE, ALBANY, NY, 12203, US

(73) Assignee: INGEN PROCESS LIMITED, Abeerdeen (GB)

(21) Appl. No.: 10/387,980

(22) Filed: Mar. 13, 2003

Related U.S. Application Data
(63) Continuation of application No. PCT/GB01/04130, filed on Sep. 17, 2001.

(30) Foreign Application Priority Data
Sep. 15, 2000 (GB) 0022688.6

(51) Int. Cl. B01D 53/14; E21B 43/00

(52) U.S. Cl. 95/236; 166/267; 166/268

(57) ABSTRACT

A process and equipment for extracting and disposing of sour reservoir components initially contained in natural hydrocarbons. The stream of natural hydrocarbons extracted from a reservoir is initially subjected to an optional gas/liquid separation. The gaseous hydrocarbons are then scrubbed with a liquid absorbent to dissolve sour reservoir components such as hydrogen sulphide and carbon dioxide and thereby form a solution. The liquid absorbent may be water that is preferably sufficiently free of oxygen and solids to be of a quality suitable for re-injection. The solution is pumped back into a well. The well may be the reservoir that produced the hydrocarbons, or adjacent geological formations, with the re-injected sour water being employed for production stimulation. Alternatively, the well may be a depleted reservoir. The scrubber may be a multiple-stage packed column or tray column that preferably allows for condensate skimming.

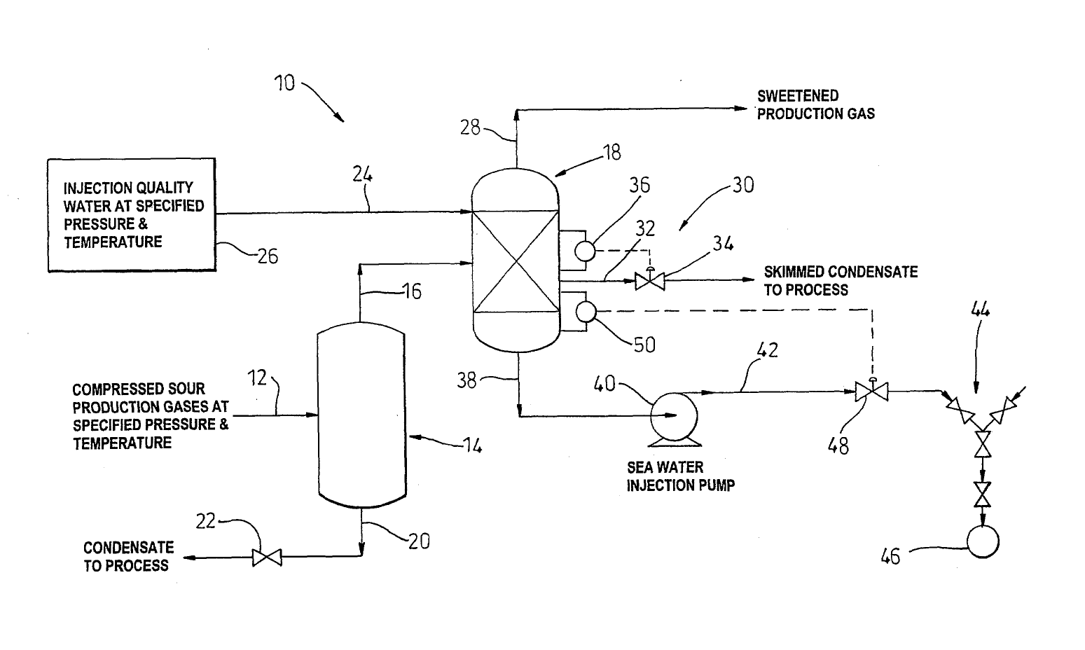

### CROSS REFERENCE TO RELATED APPLICATIONS

This application is a continuation of PCT/GB01/04130 filed Sep. 17, 2001 and published, in English, as WO 02/24838 A1 on Mar. 28, 2002 and claims priority from British patent application no. 0022688.6 filed Sep. 15, 2000, the entire contents of which are incorporated herein by reference.

### BACKGROUND OF THE INVENTION

1. Field of the Invention

This invention relates to a process and equipment for the purification of natural hydrocarbons, and relates more particularly but not exclusively to a novel process and equipment for the removal and environmentally safe disposal of sour reservoir components. The process and equipment are particularly directed to the removal of sour reservoir components, such as hydrogen sulphide (H₂S) and carbon dioxide (CO₂), from a production gas stream.

2. Description of Related Art

Buried deposits of natural hydrocarbons, known as “reservoirs”, may contain gas and/or oil, commonly contaminated with undesirable substances, e.g. hydrogen sulphide and/or carbon dioxide. Currently, hydrogen sulphide can be removed from the production gas stream through a number of means. The most common means are absorption processes and chemical treatment.

Absorption with water or another absorbent, such as amines, can be used to remove H₂S and CO₂, however the regeneration of the used absorbent stream, through pressure reduction and heating to drive off the sour components, results in the release of a sour-gas-rich gaseous stream which is normally incinerated. The burning of H₂S results in the formation and emission of acid SOX gases which are known to be harmful to the environment.

Chemical reactants, such as triazine injected into the production streams or beds packed with zinc oxide, are used to remove reservoir H₂S through chemical reaction. The high quantities of reactants required to achieve the necessary reduction in H₂S concentration usually results in a high chemical usage and consequent high operating cost.

### BRIEF SUMMARY OF THE INVENTION

The present invention aims to provide a process and equipment by which the bulk of the sour gas reservoir components can be removed from a production gas stream, at a relatively low operating cost, and returned to the reservoir for environmentally safe disposal.

According to a first aspect of the present invention there is provided a process for the separation and disposal of sour reservoir components initially contained in natural hydrocarbon produced from a reservoir, the process being characterized in that it includes the steps of absorbing the sour reservoir components in a liquid absorbent to form a solution and injecting said solution into a well.

Preferably, the liquid absorbent is water.

Advantageously, the step of absorbing is performed within a contractor column that is a multiple-stage packed column, or tray column.

Preferably, the natural hydrocarbons and sour reservoir components are gaseous and are compressed in a gas compression means prior to being treated by said process.

According to a second aspect of the present invention there is provided equipment for the separation and disposal of sour reservoir components, said equipment being characterized by including absorbing means, hydrocarbon feeding means for feeding said absorbing means with natural hydrocarbons containing sour reservoir components, a source of liquid absorbent, absorbent feeding means for feeding said absorbing means with liquid absorbent from said source, said absorbing means functioning in use of said equipment to scrub said natural hydrocarbons with said liquid absorbent so as to dissolve said sour reservoir components in said liquid absorbent and thereby form a solution, and solution discharging means for discharging said solution from said absorbing means.

Said equipment preferably further comprises solution injection means for re-injecting said solution into the reservoir that produced said natural hydrocarbons, or into geological formations adjacent said reservoir.

Said absorbing means is preferably a contactor column that may be a multiple-storage packed column or tray column.

Said source of liquid absorbent is preferably a source of water, and the water is preferably rendered substantially free of oxygen and substantially free of solids.

Said hydrocarbon feeding means may include heating means and/or pressurization means operable to cause hydrocarbons to be fed to said absorbing means at predetermined temperatures and/or at predetermined pressures.

According to a third aspect of the present invention there is provided a process for disposing of sour water, said process comprising the step of re-injecting said sour water into a hydrocarbon reservoir. Said hydrocarbon reservoir may be a producing reservoir or a depleted reservoir.

### BRIEF DESCRIPTION OF THE DRAWING

Embodiments of the invention will now be described by way of example with reference to the accompanying drawing, the sole FIGURE of which is a schematic diagram of a preferred embodiment.

### DETAILED DESCRIPTION

It is envisaged that the process and equipment of the preferred embodiment will be operated within a gas production compression and treatment train that may be located immediately downstream of a gas-producing wellhead. It should be noted that this configuration is given by way of example only and that the invention is by no means limited to a single configuration.

Sour, wet, gases from production separators (not shown) are compressed in a typical gas compression train and these gases are then delivered to a sour gas scrubbing system 10 as shown in the sole FIGURE of the accompanying drawing. (Separate compression of the sour gases will not be necessary if the operating pressure of the production separators is maintained at a sufficiently high pressure to permit treatment of the sour gases in the system 10 without the need for compression facilities).

The operating conditions of the scrubbing system 10 are carefully chosen to maximize the effectiveness of the water scrubbing operation, whilst preventing hydrocarbon condensate formation and hydrate formation.

The sour production gases in the incoming stream 12 are conditioned by controlled heating or cooling to approximately 30° Celsius and delivered via a gas/liquid separator 14 to ensure adequate separation of production gas from any condensed hydrocarbons and water. The separated gas stream 16 output from the separator 14 is routed to a sour gas contactor 18 while the separated liquid hydrocarbon and water stream 20 output from the separator 14 is routed back to the upstream production separators through a suitable flow control valve 22.

The contactor 18 is fed along a supply line 24 with injection-grade water from a water supply 26. Within the contactor 18, the separated gas stream 16 is contacted counter-currently with the water absorbent stream 24. The contactor 18 is in the form of a column that is a multiple-stage packed column or a multiple-stage tray column. The absorbent stream 24 strips water soluble components, those of particular interest being H₂S and CO₂ from the production gas stream 16 as the counter-current production gas and water absorbent streams contact each other within the contactor 18. The resultant production gas stream 28 exits the sour gas contactor 18 with a much reduced H₂S and CO₂ component concentration. This wet, sweetened, production gas stream 28 is then routed to downstream facilities (not shown) for further treatment, typically drying, and delivery.

Depending upon the effectiveness of a specific design, some further final polishing of the gas stream 28 may be necessary to ensure the delivery sour gas component specification.

Absorbent water from the source 26 is injection quality water. Oxygen-free and filtered seawater or produced water may be used as the absorbent. The absorbent water stream 24 will be conditioned to a few degrees Celsius higher than the temperature of the sour gas production stream 16 to prevent hydrocarbon gas condensation within the contactor 18. The absorbent water stream 24 is delivered to the sour gas contactor 18 at a suitable pressure through use of a dedicated pump (not shown) or through a tie-in to an injection water distribution system (not shown) of adequate operating pressure.

It is to be understood that the performance requirements for heating, cooling and pressure generating equipment, necessary to achieve the required supply conditions for the sour production gas stream 16 and the absorbent water stream 28, are dependent upon the associated compression systems and water injection system.

The contactor 18 is a typical design similar to gas dehydration glycol contactors in use in the offshore oil and gas industry, i.e. packed columns or tray columns. This contactor design will include a skimming facility 30 to remove any hydrocarbon condensate which may accumulate within the contactor 18. This may occur as a result of condensation within the contactor 18 or associated pipework or from poor separation within the upstream separation facility 14. Condensate is tapped from the contactor 18 along a discharge line 32 under the control of valve 34 operated by a condensate level sensor 36 suitably coupled to the contactor 18. Skimmed condensate will be routed back to the upstream production separators.

The water stream 38, rich in absorbed sour components that results from operation of the contactor 18, is discharged from the bottom of the contactor 18 and is routed to a water injection pump 40 to raise the pressure of the sour water stream 38 to the required reservoir injection pressure. The water injection pump discharge 42 is routed to a water injection wellhead 44, from where it is conducted into the disposal or pressure maintenance reservoir 46. The pump discharge 42 is controlled by a suitable valve 48 that is operated by a level controller 50 suitably coupled to the contactor 18.

In typical use of the invention it will be appropriate to analyze the vapor liquid equilibria and to assess the optimum operating conditions of the sour gas contactor 18. Higher pressure operation increases the partial pressure of particular components in the gas stream 16, which consequently increases their solubility in water. Solubility also increases with reduced absorbent temperature, however the possibility of hydrate formation at high operating pressures must be guarded against.

The inventive process of sour water re-injection will be advantageous to oil and gas processing systems where operating costs and environmental impact must be minimized. A typical example of the benefit of this sour water re-injection system would be seen in its application to a new reservoir development where the cost of removing sour gases has a significant contribution to the economics of the project.

Another advantage of this invention is that it combines known technologies and methods in a simple way to give a low risk, low cost, alternative sour gas separation and disposal system. The operability of the invention can be easily assessed using industry standard process simulation tools.

Modifications and variations of the invention can be adopted without departing from the scope of the invention as defined in the appended claims. For example, liquid absorbents other than water can be employed, and suitable contactors other than packed columns or tray columns can be employed for absorbing sour components in the natural hydrocarbons.

What is claimed is:

1. A process for the separation and disposal of sour reservoir components initially contained in natural hydrocarbons produced from a reservoir, the process comprising: absorbing the sour reservoir components in a liquid absorbent to form a solution and injecting said solution into a well.

2. A process as claimed in claim 1 wherein the liquid absorbent is water.

3. A process as claimed in claim 1 wherein the absorption is performed within a contactor column.

4. A process as claimed in claim 3 wherein the column is a multiple-stage packed column.

5. A process as claimed in claim 3 wherein the column is a multiple-stage tray column.

6. A process as claimed in claim 1 wherein the natural hydrocarbons and sour reservoir components are gaseous and are compressed in a gas compression means prior to being treated by said process.

7. Equipment for the separation and disposal of sour reservoir components, said equipment including: absorbing means, hydrocarbon feeding means for feeding said absorbing means with natural hydrocarbons containing sour reservoir components, a source of liquid absorbent, absorbent feeding means for feeding said absorbing means with liquid absorbent from said source, said absorbing means functioning in use of said equipment to scrub said natural hydrocarbons with said liquid absorbent so as to dissolve said sour reservoir components in said liquid absorbent and thereby form a solution, and solution discharging means for discharging said solution from said absorbing means.

8. Equipment as claimed in claim 7 wherein said equipment further comprises solution injection means for re-injecting said solution into a reservoir that produced said natural hydrocarbons, or into geological formations adjacent said reservoir.

9. Equipment as claimed in claim 7 wherein said absorbing means is a contactor column.

10. Equipment as claimed in claim 9 wherein said contactor column is a multiple-stage packed column.

11. Equipment as claimed in claim 9 wherein said contactor column is a multiple-stage tray column.

12. Equipment as claimed in claim 7 wherein said source of liquid absorbent is a source of water.

13. Equipment as claimed in claim 12 wherein said source of water is a source of water that is substantially free of oxygen.

14. Equipment as claimed in claim 12 wherein said source of water is a source of water that is substantially free of solids.

15. Equipment as claimed in claim 7 wherein said hydrocarbon feeding means includes heating means operable to cause hydrocarbons to be fed to said absorbing means at predetermined temperatures.

16. Equipment as claimed in claim 7 wherein said hydrocarbon feeding means includes pressurization means operable to cause hydrocarbons to be fed to said absorbing means at predetermined pressures.

17. A process for disposing of sour water, including a step of re-injecting said sour water into a hydrocarbon reservoir.

18. A process as claimed in claim 17 wherein said reservoir is a producing reservoir.

19. A process as claimed in claim 17 wherein said reservoir is a depleted reservoir.
